(19) United States
(12) Patent Application Publication
(10) Pub. No.: US 2017/0120915 A1
(43) Pub. Date: May 4, 2017

(54) METHOD OF OPTIMIZING FUEL EFFICIENCY AND PERFORMANCE OF A CVP BASED SYSTEM BY SELECTING CONTROL POINTS TO MINIMIZE TOTAL SYSTEM LOSSES

(71) Applicant: Dana Limited, Maumee, OH (US)

(72) Inventors: Jeffrey M. DAVID, Cedar Park, TX (US); T. Neil McLEMORE, Georgetown, TX (US)

(21) Appl. No.: 15/337,533

(22) Filed: Oct. 28, 2016

Related U.S. Application Data
(60) Provisional application No. 62/249,810, filed on Nov. 2, 2015.

(51) Int. Cl. B60W 30/188; B60W 10/108; B60W 10/06

(52) U.S. Cl. CPC B60W 30/188; B60W 10/06; B60W 10/108; B60W 2510/0638; B60W 2510/0657; B60W 2510/1005; B60W 2510/104; B60W 2510/105; B60W 2520/10; B60W 2710/0644; B60W 2710/0666; B60W 2710/1005; B60W 2510/305

(57) ABSTRACT

Described herein is a control system for a vehicle having a continuously variable transmission (CVT) having a ball planetary variator (CVP), providing a smooth and controlled operation. In some embodiments, the control system implements an optimization sub-module. System losses in a CVP equipped vehicle consist of the following: CVP efficiency losses, hydraulic pump losses, clutch energy losses, mode shift losses, torque converter losses, and engine losses (defined as deviation from best Brake Specific Fuel Consumption point), among others. Driver torque demand can be satisfied by an infinite combination of operating points consisting of a chosen engine operating point, CVP ratio, and mode selection. The required clamping load and line pressure requirements resulting from these choices further influences losses. Methods described herein select a system operating point that minimizes total system losses.

### CROSS-REFERENCE

The present application claims priority to U.S. Provisional Patent Application No. 62/249,810, filed Nov. 2, 2015, which is incorporated herein by reference in its entirety.

### BACKGROUND OF THE INVENTION

Infinitely variable transmissions (IVT) and continuously variable transmissions (CVT) are becoming more in demand for a variety of vehicles as they offer performance and efficiency improvements over standard fixed gear transmissions. Certain types of IVTs and CVTs that employ ball-type continuously variable planetary (CVP) transmissions often have shift actuators coupled to the CVP for control of speed ratio during operation of the transmission. Implementation of a CVT into a vehicle can improve vehicle performance and efficiency. However, some continuously variable transmissions have unique operating characteristics compared to traditional geared transmissions. It is desirable for the transmission control system to manage the CVT under all operating conditions the vehicle will encounter in the most efficient means possible. Therefore a new control method is needed to select operating conditions for the CVT that optimize the overall efficiency and performance of the powertrain.

### SUMMARY OF THE INVENTION

Provided herein is a computer-implemented system for a vehicle having an engine coupled to a continuously variable transmission having a ball-planetary variator (CVP), the CVP having a plurality of balls, each ball provided with a tiltable axis of rotation, each ball supported in a carrier assembly, the carrier assembly operably coupled to a shift actuator, the computer-implemented system comprising: a digital processing device comprising an operating system configured to perform executable instructions and a memory device; a computer program including instructions executable by the digital processing device, the computer program comprising a software module configured to manage the CVP and the engine; a plurality of sensors configured to monitor vehicle parameters comprising: a transmission output shaft speed sensor configured to sense an engine speed, an engine speed sensor configured to sense an engine speed, an engine torque sensor configured to sense an engine torque, a vehicle speed sensor configured to sense a vehicle speed, a CVP ratio indicator configured to indicate a CVP ratio, and a commanded transmission output torque indicator configured to indicate a commanded transmission output torque; wherein the software module is adapted to determine a commanded CVP ratio based at least in part on the commanded transmission output torque, the transmission output shaft speed, the engine speed, the engine torque, and the vehicle speed.

In some embodiments of the computer-implemented system, the software module further comprises a solution set generator, a sub-system loss model, and a total system loss sub-module.

In some embodiments of the computer-implemented system, the sub-system loss sub-module further comprises a CVP loss sub-system module.

In some embodiments of the computer-implemented system, the sub-system loss sub-module further comprises an engine loss sub-system module.

In some embodiments of the computer-implemented system, the sub-system loss sub-module further comprises a hydraulic pump loss sub-system module.

In some embodiments of the computer-implemented system, the sub-system loss sub-module further comprises a torque converter loss sub-system module.

In some embodiments of the computer-implemented system, the total system loss sub-module is configured to determine the minimum total loss from a set of operating conditions.

In some embodiments of the computer-implemented system, the set of operating conditions are determined in the solution set generator.

In some embodiments of the computer-implemented system, the solution set generator determines a set of operating conditions that satisfy the commanded transmission output torque.

In some embodiments of the computer-implemented system, the total system loss sub-module is configured to determine a commanded CVP ratio based at least in part on the minimum total loss.

In some embodiments of the computer-implemented system, the solution set generator is configured to determine a set of CVP ratio solutions based at least in part on the vehicle speed and the commanded transmission output torque.

In some embodiments of the computer-implemented system, the solution set generator is configured to determine a set of engine speed solutions and a set of engine torque solutions, wherein the set of engine speed solutions and the set of engine torque solutions are based at least in part on the set of CVP ratio solutions.

In some embodiments of the computer-implemented system, the total system loss sub-module further comprises a total loss minimization function.

In some embodiments of the computer-implemented system, the total loss minimization function is configured to execute a process, the process comprising the steps of: receiving a total loss set comprising an indexed array of solutions for total system loss; receiving an input power set comprising an indexed array of solutions for input power; comparing the input power set to a requested input power signal; and selecting a minimum total loss operating condition based at least in part on the comparison of the requested input power signal to the input power set.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a block diagram of a basic driveline configuration of a continuously variable transmission (CVT) used in a vehicle.

FIG. 5 is a block diagram schematic of an optimization sub-module that can be implemented in a control system for the driveline of FIG. 4.

FIG. 6 is a block diagram of a solution set generator that can be implemented in the optimization sub-module of FIG. 5.

FIG. 7 is a flow chart of a CVP solution set function that can be implemented in the solution set generator of FIG. 6.

FIG. 8 is a flow chart of an engine solution set function that can be implemented in the solution set generator of FIG. 6.

FIG. 9 is a block diagram of an engine loss sub-system that can be implemented in the optimization sub-module of FIG. 5.

FIG. 10 is a block diagram of a CVP loss sub-system that can be implemented in the optimization sub-module of FIG. 5.

FIG. 11 is a flow chart of a minimization function that can be implemented in the CVP loss-sub-system of FIG. 10.

FIG. 12 is a block diagram of a hydraulic pump loss sub-system that can be implemented in the optimization sub-module of FIG. 5.

FIG. 13 is a block diagram of a torque converter loss sub-system that can be implemented in the optimization sub-module of FIG. 5.

FIG. 14 is a block diagram of a total system loss sub-module that can be implemented in the optimization sub-module of FIG. 5.

FIG. 15 is a flow chart of a total loss minimization function that can be implemented in the total system loss sub-module of FIG. 14.

### DETAILED DESCRIPTION OF THE INVENTION

Described herein is a control system for a vehicle having a continuously variable transmission (CVT) having a ball planetary variator (CVP), providing a smooth and controlled operation. In some embodiments, the control system implements an optimization sub-module. System losses in a CVP equipped vehicle consist of the following: CVP efficiency losses, hydraulic pump losses, clutch energy losses, mode shift losses, torque converter losses, and engine losses (defined as deviation from best Brake Specific Fuel Consumption (BSFC) point), among others. Driver torque demand can be satisfied by an infinite combination of operating points consisting of a chosen engine operating point, CVP ratio, and mode selection. The required clamping load and line pressure requirements resulting from these choices further influences losses. Methods described herein will select system operating point that minimizes total system loss.

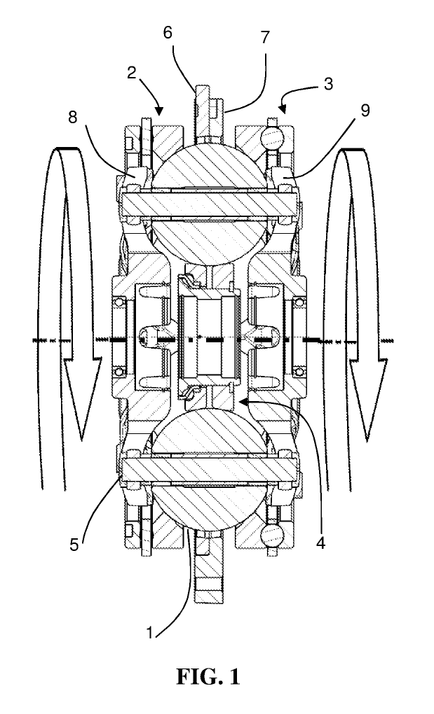

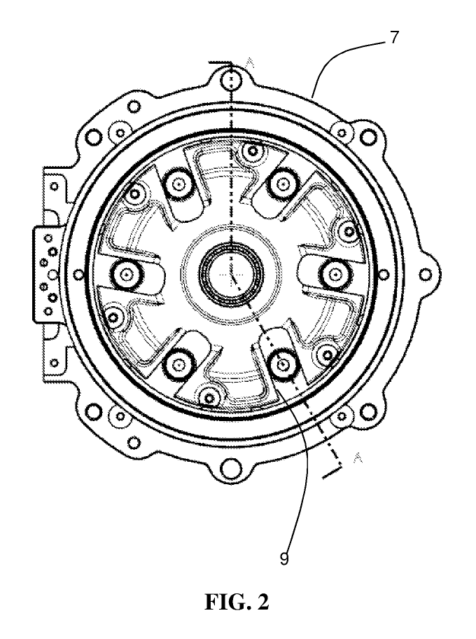

Provided herein are configurations of CVTs based on ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input ring 2 and output ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 can be substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first carrier member and the second carrier member to impart a tilting of the axles 5 and thereby adjusts the speed ratio of the variator. The speed ratio of the variator is sometimes referred to as “CVP ratio”, “CVP speed ratio”, “torque ratio”, and/or “CVP torque ratio”. Other types of ball CVTs also exist, like the one produced by Milner, but are slightly different.

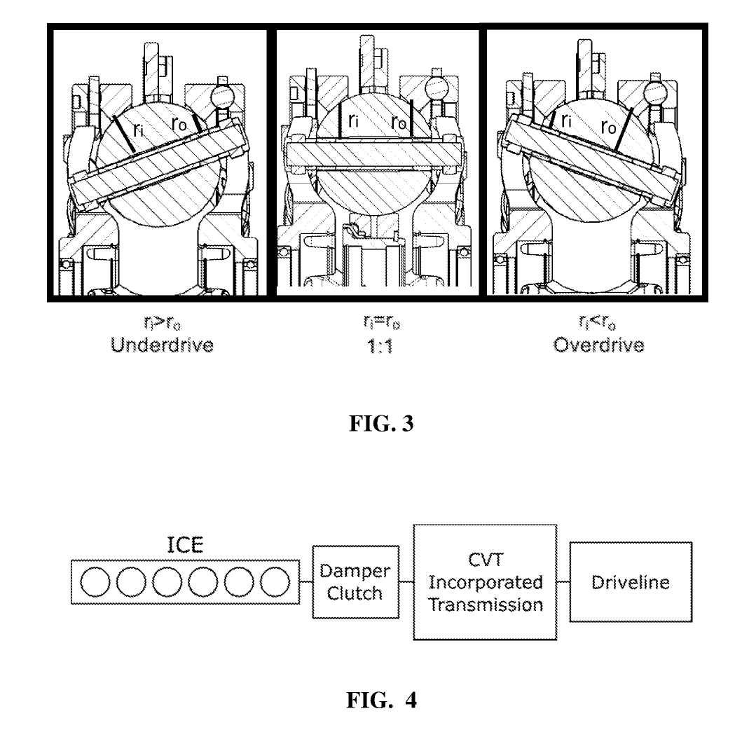

The working principle of such a CVP of FIG. 1 is shown on FIG. 2. The CVP itself works with a traction fluid. The lubricant between the ball and the conical rings acts as a solid at high pressure, transferring the power from the input ring, through the balls, to the output ring. By tilting the balls' axes, the ratio can be changed between input ring and output ring. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that can be adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives here, generally these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here will operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source can be fueled by energy sources comprising hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission comprising this technology.

For description purposes, the terms “electronic control unit”, “ECU”, “Driving Control Manager System” or “DCMS” are used interchangeably herein to indicate a vehicle's electronic system that controls subsystems monitoring or commanding a series of actuators on an internal combustion engine to ensure optimal engine performance. It does this by reading values from a multitude of sensors within the engine bay, interpreting the data using multidimensional performance maps (called lookup tables), and adjusting the engine actuators accordingly. Before ECUs, air-fuel mixture, ignition timing, and idle speed were mechanically set and dynamically controlled by mechanical and pneumatic means.

Those of skill will recognize that brake position and throttle position sensors can be electronic, and in some cases, well-known potentiometer type sensors. These sensors can provide a voltage or current signal that is indicative of a relative rotation and/or compression/depression of driver control pedals, for example, brake pedal and/or throttle pedal. Often, the voltage signals transmitted from the sensors are scaled. A convenient scale used in the present application as an illustrative example of one implementation of the control system uses a percentage scale 0%-100%, where 0% is indicative of the lowest signal value, for example a pedal that is not compressed, and 100% is indicative of the highest signal value, for example a pedal that is fully compressed. In some embodiments, there are implementations of the control system where the brake pedal is effectively fully engaged with a sensor reading of 20%-100%. Likewise, in some embodiments, a fully engaged throttle pedal corresponds to a throttle position sensor reading of 20%-100%. The sensors, and associated hardware for transmitting and calibrating the signals, can be selected in such a way as to provide a relationship between the pedal position and signal to suit a variety of implementations. Numerical values given herein are included as examples of one implementation and not intended to imply limitation to only those values. For example, in some embodiments, a minimum detectable threshold for a brake pedal position is 6% for a particular pedal hardware, sensor hardware, and electronic processor. Whereas an effective brake pedal engagement threshold is 14%, and a maximum brake pedal engagement threshold begins at or about 20% compression. As a further example, in some embodiments, a minimum detectable threshold for an accelerator pedal position is 5% for a particular pedal hardware, sensor hardware, and electronic processor. In some embodiments, similar or completely different pedal compression threshold values for effective pedal engagement and maximum pedal engagement are also applied for the accelerator pedal.

Those of skill will recognize that in some embodiments, the various illustrative logical blocks, modules, circuits, and algorithm steps described in connection with the embodiments disclosed herein, including with reference to the transmission control system described herein, for example, are implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein are implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. In some embodiments, a processor will be implemented as a combination of computing devices, e.g., a combination of a DSP and a microprocessor, a plurality of microprocessors, one or more microprocessors in conjunction with a DSP core, or any other such configuration. In some embodiments, software associated with such modules resides in RAM memory, flash memory, ROM memory, EPROM memory, EEPROM memory, registers, a hard disk, a removable disk, a CD-ROM, or any other suitable form of storage medium known in the art. In some embodiments, an exemplary storage medium is coupled to the processor such that the processor reads information from, and writes information to, the storage medium. In alternative embodiments, the storage medium is integral to the processor. In some embodiments, the processor and the storage medium reside in an ASIC. For example, in one embodiment, a controller for use of control of the IVT comprises a processor (not shown).

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Digital Processing Device

In some embodiments, the Control System for a Vehicle equipped with an infinitely variable transmission described herein includes a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments the Control System for a Vehicle equipped with an infinitely variable transmission disclosed herein includes one or more non-transitory computer readable storage media encoded with a program including instructions executable by the operating system of an optionally networked digital processing device. In further embodiments, a computer readable storage medium is a tangible component of a digital processing device.

### Computer Program

In some embodiments, the Control System for a Vehicle equipped with a continuously variable transmission disclosed herein includes at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

Referring now to FIG. 4, in one embodiment, a vehicle is equipped with a driveline having a torsional damper between an engine and an infinitely or continuously variable transmission (CVT) to avoid transferring torque peaks and vibrations that could damage the CVT (called variator in this context as well). In some configurations this damper can also be coupled with a clutch for the starting function or to allow the engine to be decoupled from the transmission. In other embodiments, a torque converter (not shown), is used to couple the engine to the CVT or IVT. Other types of CVT's (apart from ball-type traction drives) can also be used as the variator in this layout. In addition to the configurations above where the variator is used directly as the primary transmission, other architectures are possible. Various powerpath layouts can be introduced by adding a number of gears, clutches and simple or compound planetaries. In such configurations, the overall transmission will provide several operating modes; a CVT, an IVT, a combined mode and so on. A control system for use in an infinitely or continuously variable transmission will now be described.

During operation of the vehicle equipped with the driveline of FIG. 4, for example, a driver's input to the vehicle is received by a vehicle controller (not shown) and converted into the appropriate commands to the engine and the CVP. It should be appreciated that for a given driver request, there are multiple CVP and engine operating conditions that satisfy the request. For example, a driver's request is converted into a request at the output shaft and/or drive wheels for 100 Nm of torque at 2000 rpm, there are many combinations of engine speed, engine torque, and CVP ratio that can satisfy that request. For instance, engine torque of 100 Nm, engine speed of 2000 rpm and CVP ratio of 1 satisfies the request. Engine torque of 50 Nm, engine speed of 4000 rpm, and CVP ratio of 0.5 also satisfies the request. Engine torque of 200 Nm, engine speed of 1000 rpm, and CVP ratio of 2.0 also satisfies the request. Selecting the optimal operating condition for the engine and CVP is necessary. In one embodiment, operating the vehicle in the most efficient mode possible is important, therefore the criteria for optimization or selection of the best operating condition for the engine and CVP is selected for minimum losses in the system. In other embodiments, operating the vehicle to provide the best performance is important, therefore the criteria for optimization or selection of the best operating condition for the engine and CVP is selected for maximum power, for example. It should be appreciated, that embodiments disclosed herein can be calibrated and adapted to reflect the hardware implemented in the driveline.

System losses in a CVP equipped vehicle consist of the following: CVP efficiency losses, hydraulic pump losses, clutch energy losses, mode shift losses, torque converter losses, and engine losses (defined as deviation from best BSFC point), among others. Brake specific fuel consumption (BSFC) is a measure of the fuel efficiency of any prime mover that burns fuel and produces rotational, or shaft, power. It is typically used for comparing the efficiency of internal combustion engines with a shaft output. It is the rate of fuel consumption divided by the power produced. It may also be thought of as power-specific fuel consumption, for this reason. BSFC allows the fuel efficiency of different engines to be directly compared. Driver torque demand can be satisfied by an infinite combination of operating points consisting of a chosen engine operating point, CVP ratio, and mode selection. The required clamping load and line pressure requirements resulting from these choices further influences losses. Methods described herein will select system operating point that minimizes total system loss.

Methods disclosed herein can be implemented as an offline simulation tool that develops a set of calibration tables that define a rule based control strategy. Offline simulation tools can evaluate an infinite number of points as simulation time allows. Alternatively, methods can be implemented real time in a controller to dynamically optimize system operating points in vehicle. Real time execution would rely on a rule based table to choose a set of operating points in close proximity to offline simulation results at some arbitrary loop execution rate. In smaller increments of that loop rate each potential set of operating points is evaluated and the minimum loss point is selected.

Methods disclosed herein are executed as follows: For a given driver torque command the best BSFC operating point is chosen and system losses are calculated as a baseline. The control sub-system then generates alternative operating points that deviate from best BSFC operation point. System losses are calculated again and the operating point that minimizes total loss is selected.

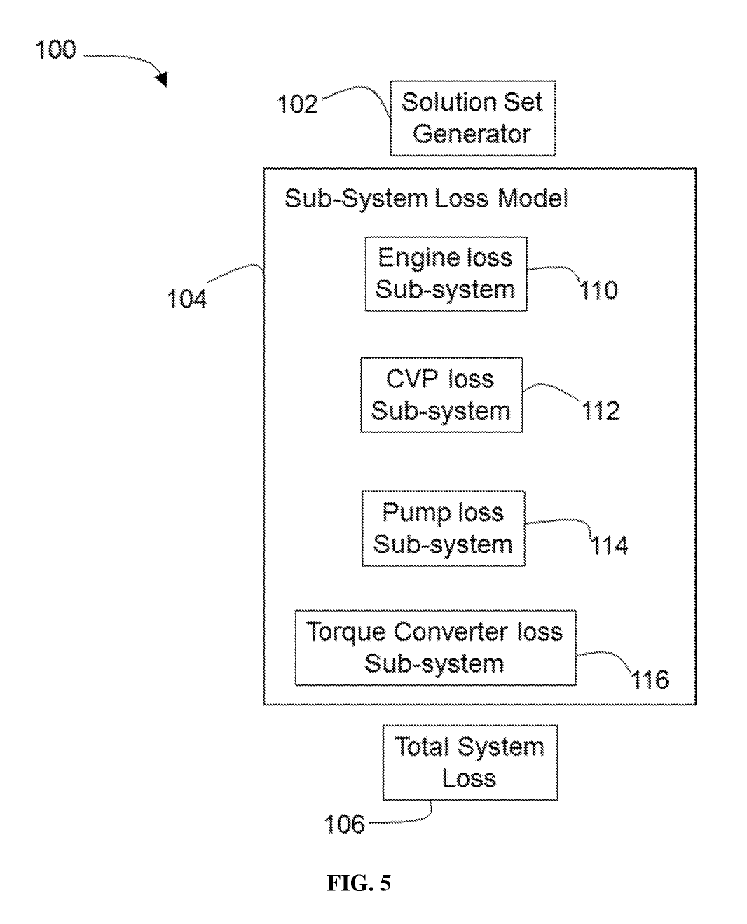

Referring now to FIG. 5, in one embodiment, an optimization sub-module 100 is used in a computer-implemented powertrain controller configured to control the operation of the CVP and/or driveline depicted in FIG. 4. For clarity and conciseness, only certain aspects of the powertrain controller are described. It should be appreciated, that the powertrain controller is configured to receive and send a number of signals indicative of operating conditions in the transmission, engine, and/or vehicle in order to control the powertrain. In one embodiment, the powertrain controller is provided with a number of calibration tables and/or variables. The powertrain controller is typically in communication with an engine control unit and/or a vehicle control unit, among other modules, for sending and receiving signals during the operation of the vehicle. In one embodiment, the optimization sub-module 100 includes a solution set generator 102, a sub-system loss model 104, and a total system loss sub-module 106. In one embodiment, the sub-system loss model 104 includes an engine loss sub-system 110, a CVP loss sub-system 112, a hydraulic pump loss sub-system 114, and a torque converter loss sub-system 116. It should be appreciated that the sub-system loss model 104 can be adapted to include any sub-system equipped on the vehicle that contributes to the overall vehicle efficiency. It should also be appreciated that for drivelines not equipped with a torque converter, that the sub-system loss model 104 would not include a torque-converter loss sub-system. Furthermore, it should be appreciated that each sub-system loss model can implement models associated with particular aspects of the sub-system contributing to energy losses during operation. The embodiments of the sub-system loss model 104 provided herein are for a driveline having an engine, a torque converter, a multi-mode continuously variable transmission, and a hydraulic system, as an illustrative example. In other embodiments, the sub-system loss model 104 can be adapted to include models associated with hybrid vehicle drivelines, such as, but not limited to, electric motors, batteries, charging system components, hydraulic accessories, hydraulic accumulators, and pumps, among others.

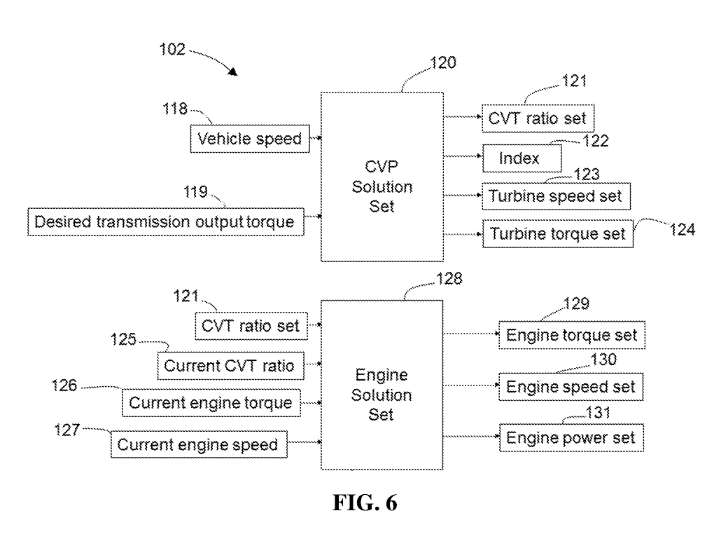

Referring now to FIG. 6, in one embodiment, the solution set generator 102 is adapted to receive a vehicle speed signal 118 and a desired transmission output torque signal 119. The vehicle speed signal 118 and the desired transmission output torque signal 119 is passed to a CVP solution set function 120. The CVP solution set function 120 delivers output signals for a CVT ratio set 121, an index 122, a turbine speed set 123, and a turbine torque set 124 that satisfy the desired transmission output torque signal 119 and vehicle speed signal 118. For systems that do not contain a torque converter the CVT ratio solution set, required transmission output torque, and CVP efficiency lookup tables can be used directly to determine linearly the CVP input speed and torque associated with each solution. In this case the torque converter loss modeling subsystem would not be necessary. For example, the CVP solution set function 120 generates a set of 28 potential solutions spanning full CVT ratio range (0.18-1.24 in 0.04 increments). In one embodiment, a solution set can be arranged with more than or less than 28 potential ratio values dependent on desired level of fidelity or on board computation resource limitations, etc. For example, 10 possible solutions in 0.10 increments and a rate limiter automatically filters the output for improved drivability and reduces processor load. In some embodiments, 106 solutions in 0.01 increments improves accuracy and chances of arriving at ideal solution at the expense of processor load and would require extensive filtering on the output. In yet other embodiments, the open loop ratio command lookup tables could be used as a starting point and the solution set could be generated from a calibratable ratio delta above and below the open loop value. This would allow the optimization search engine to concentrate on a range of likely solutions rather than consuming computing resources on solutions we would logically never choose.

Still referring to FIG. 6, in one embodiment, the solution set generator 102 is adapted to receive a current CVT ratio signal 125, a current engine torque signal 126, and a current engine speed signal 127. The CVT ratio set 121, the current CVT ratio signal 125, the current engine torque signal 126, and the current engine speed signal 127 are received by an engine solution set function 128. The engine solution set function 128 generates an engine torque set 129, an engine speed set 130, and an engine power set 131 based on the CVT ratio set 121.

Turning now to FIG. 7, in one embodiment, the CVP solution set function 120 can implement a process that begins at a state 135 and passes to a block 136 where signals are received. In one embodiment, signals indicative of a desired vehicle speed, a current vehicle speed, a desired transmission output torque, a current transmission output torque, among others, are received. The process proceeds to a block 137 where a turbine speed set is determined based at least in part on the vehicle speed signal, the transmission output torque signal, and a modeled representation of the torque converter dynamics. As discussed previously, the set can include a pre-determined quantity of indexed values. In one embodiment, the turbine speed set includes 28 values of turbine speed. The process proceeds to a block 138 where a turbine torque set is determined based at least in part on the vehicle speed signal, the transmission output torque signal, and CVP efficiency lookup tables. In one embodiment, the turbine torque set includes the same number of indexed values as the turbine speed set. The process proceeds to a block 139 that sends the turbine speed set and the turbine torque set as indexed sets or matrices for use by other modules or sub-systems in the control system. The process returns to the block 136.

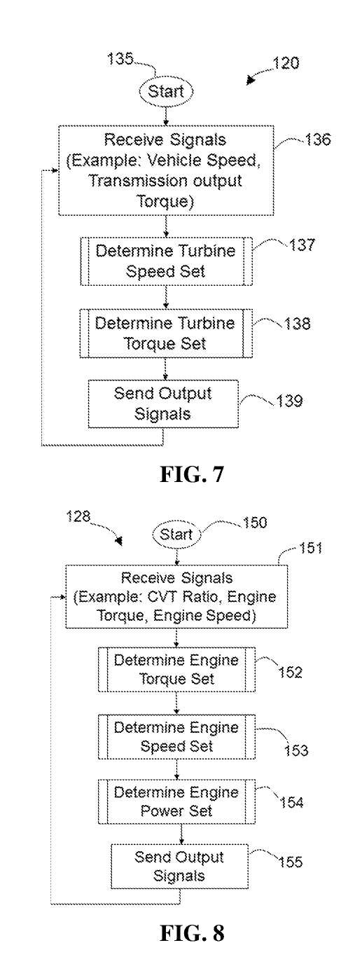

Turning now to FIG. 8, in one embodiment, the engine solution set function 128 can implement a process that begins at a state 150 and proceeds to a block 151 where signals are received. In one embodiment, the block 151 receives a CVT ratio signal, an engine speed signal, and engine torque signal, among others. The process proceeds to a block 152 where an engine torque set is determined based at least upon a CVT ratio set. In one embodiment, the engine torque set is a matrix of indexed values. The process proceeds to a block 153 where an engine speed set is determined based at least upon a CVT ratio set. The process proceeds to a block 154 where an engine power set is determined based at least upon the engine speed set and the engine torque set. The process proceeds to a block 155 where the engine torque set, the engine speed set, and the engine power set are sent as signals for use by other modules or sub-systems in the control system. The process returns to the block 151.

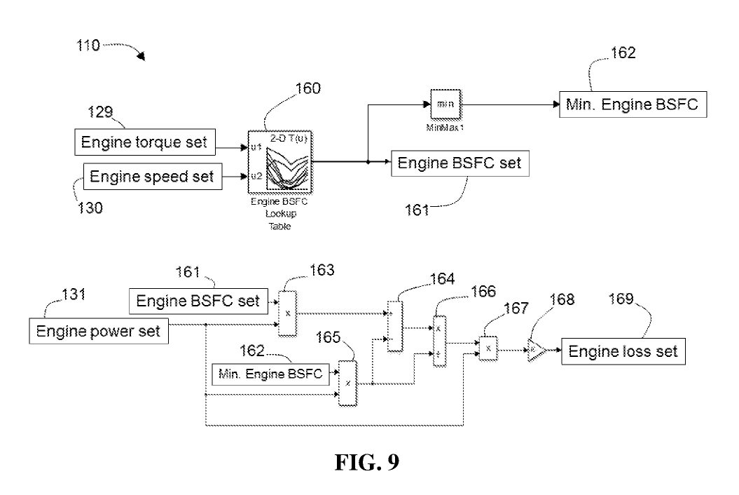

Passing now to FIG. 9 in one embodiment, the engine loss sub-system 110 can include a look-up table 160 that stores values for the engine's brake specific fuel consumption (BSFC) based at least in part on the engine speed and the engine torque. In one embodiment, the look-up table 160 receives the engine torque set 129 and the engine speed set 130 as input variables. The look-up table 160 returns an engine BSFC set 161 having a common index with the engine speed set 129 and the engine torque set 130. A minimum engine BSFC signal 162 can be determined that is indicative of the lowest value included in the engine BSFC set 161. The engine loss sub-system 110 is adapted to receive the engine power set 131. Each indexed value of the engine power set 131 is passed to a multiplier 163 that multiplies the engine power set 131 by the engine BSFC set 161 to form a quotient. The quotient is passed to a summation block 164 that determines the difference between the quotient determined by the multiplier 163 and a quotient determined by the multiplier 165. The multiplier 165 receives the engine power set 131 and multiplies each value by the minimum engine BSFC signal 162. The result of the multiplier 165 is passed to a divider block 166. The result of the divider block 166 is passed to a multiplier block 167. The result of the multiplier block 167 is passed to a gain 168 to form an engine loss set 169. The engine loss set 169 is an indexed array of values associated with the engine speed set 129, the engine torque set 130, and the engine power set 131. The overall goal of this subsystem is to calculate a ratio of additional fuel consumption above the minimum engine BSFC choice for each element of the potential solution set. This additional fuel consumption represent a lost opportunity cost associated with choosing an operating point that deviates from the ideal engine BSFC solution.

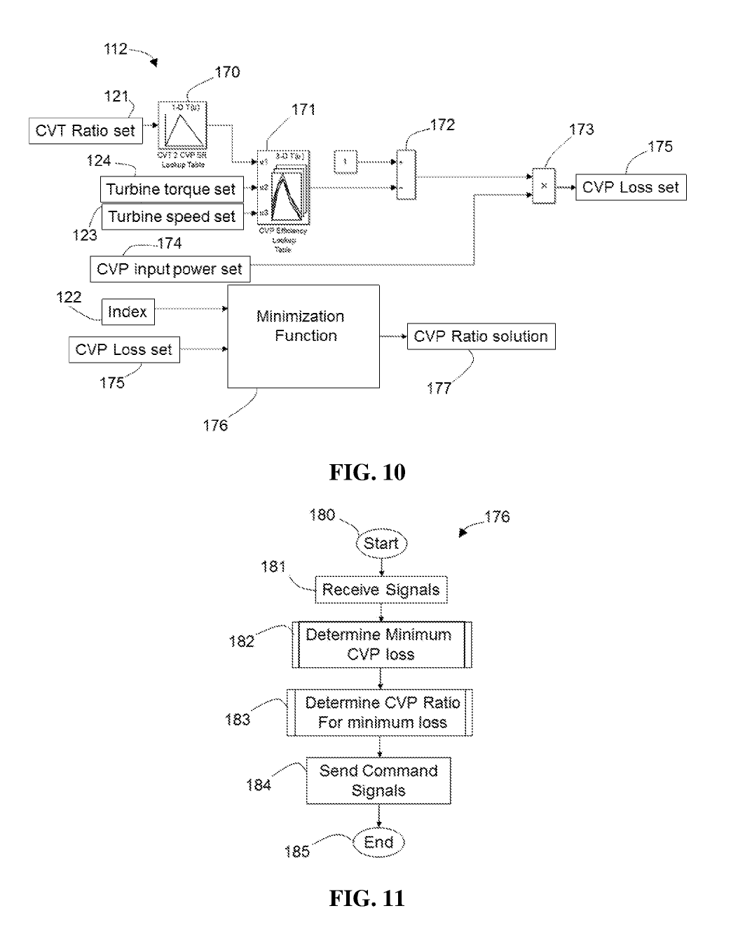

Referring now to FIG. 10, in one embodiment, the CVP loss sub-system 112 is configured to receive the CVT ratio set 121, the index 122, the turbine speed set 123, and the turbine torque set 124, among others. The CVT ratio set 121 is an input signal to a CVP ratio look-up table 170. The CVP ratio look-up table 170 is adapted to store values of a CVP ratio based at least in part on the CVT ratio. It is noted that these values can be indicative of the hardware and transmission architecture implemented in the vehicle. For example, the CVT is configurable with a number of gear boxes and clutches to provide multi-mode operation. Hence, the CVP ratio will differ from the overall CVT ratio, depending on the configuration. The CVT ratio set determined in the CVP ratio look-up table 170 is passed to a CVP efficiency look-up table 171. The CVP efficiency look-up table 171 stores efficiency values based at least in part on the CVP ratio set, the turbine speed set 123, and the turbine torque set 124. The efficiency set determined in the CVP efficiency look-up table 171 is converted into a proportional loss at a summation block 172. The result of the summation block 172 is passed to a multiplier 173 where the loss is multiplied by a CVP input power set 174. In one embodiment, the CVP input power set 174 is determined in the solution set generator 102. The multiplier 173 returns a CVP loss set 175. The CVP loss set 175 is a matrix of indexed values for CVP loss associated with the CVT ratio set 121, the turbine speed set 123, and the turbine torque set 124, among others. In one embodiment, the CVP loss sub-system 112 includes a minimization function 176 configured to receive the CVP loss set 175 and the index 122. The minimization function 176 returns a CVP ratio solution signal 177. It should be noted that the minimization function 176 is a local function that considers loss from the CVP perspective only. Its purpose is for analysis and debug with the responsibility for overall optimal solution selection being the responsibility of the total loss minimization function.

Referring now to FIG. 11, in one embodiment the minimization function 176 can implement a process that begins at a start state 180 and passes to a block 181 where signals are received. In one embodiment, the block 181 receives the CVP loss set 175 and the index 122, among others. The process proceeds to a block 182 where the minimum value in the CVP loss set is found. The process proceeds to a block 183 where a CVP ratio associated with the minimum CVP loss is determined. The process proceeds to a block 184 where the commanded CVP ratio is sent. The process ends at an end state 185.

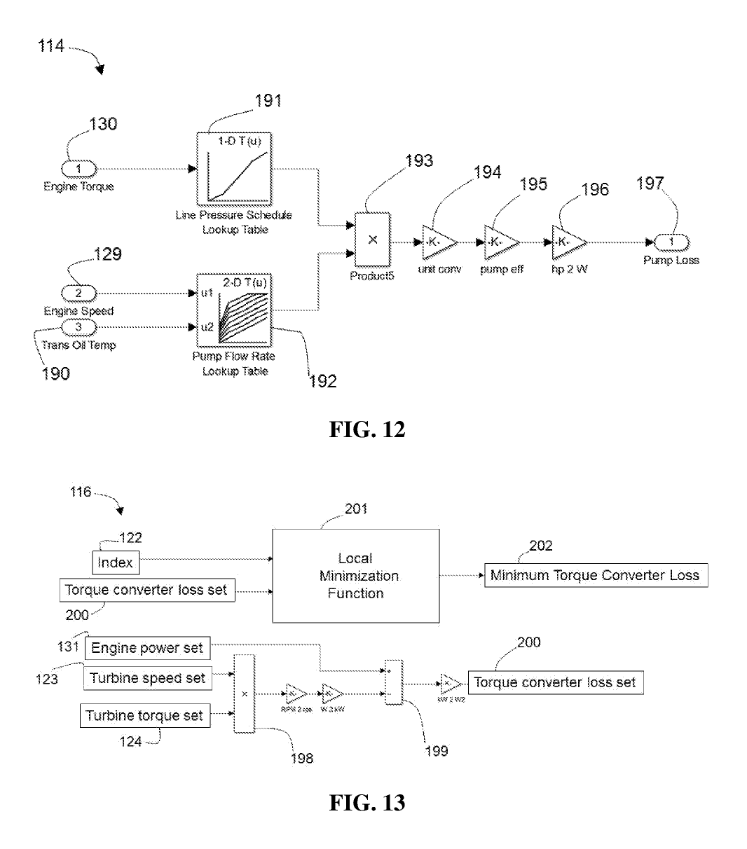

Turning now to FIG. 12, in one embodiment, the hydraulic pump loss sub-system 114 is adapted to receive the engine speed set 129, the engine torque set 130, and a transmission oil temperature signal 190. The hydraulic pump loss sub-system 114 includes a line pressure look-up table 191. The line pressure look-up table 191 is configured to store values of line pressure based at least in part on engine torque. It is noted, that hydraulic pump loss is taken into account for systems having a mechanically driven pump. In some embodiments, an electric pump is employed for providing pressurized fluid to the transmission and the losses associated with the electric pump are determined using similar methods to those disclosed herein. The hydraulic pump loss sub-system 114 can be configured to include a flow rate look-up table 192. The flow rate look-up table 192 returns a set of values for pump flow rate based at least in part on the transmission oil temperature signal 190 and the engine speed set 129. The results of the line pressure look-up table 191 and the flow rate look-up table 192 are passed to a multiplier 193. In one embodiment, a gain 194 is applied to convert units. A gain 195 is applied to account for pump efficiency. In some embodiments the pump efficiency factor 195 can be a lookup table based at least in part on pump flow rate, line pressure, and oil temperature. A gain 196 is applied to convert horsepower to watts, for example. The resulting signal is a pump loss set 197.

Referring now to FIG. 13, in one embodiment, the torque converter loss sub-system 116 is configured to receive the turbine speed set 123, the turbine torque set 124, the index 122, and the engine power set 131. A multiplier 198 multiplies the turbine speed set 123 and the turbine torque set 124 to determine a turbine power set. Conversion gains are applied to the turbine power set to match the units to the engine power set 131. A difference between the engine power set 131 and the turbine power set is determined at a difference block 199. The difference block 199 passes a torque converter loss set 200 as an output signal. The torque converter loss set 200 is received by a local minimization function 201. The local minimization function 201 determines the minimum torque converter loss value 202 in the torque converter loss set 200. The local minimization function 201 implements a process similar to the minimization function 176.

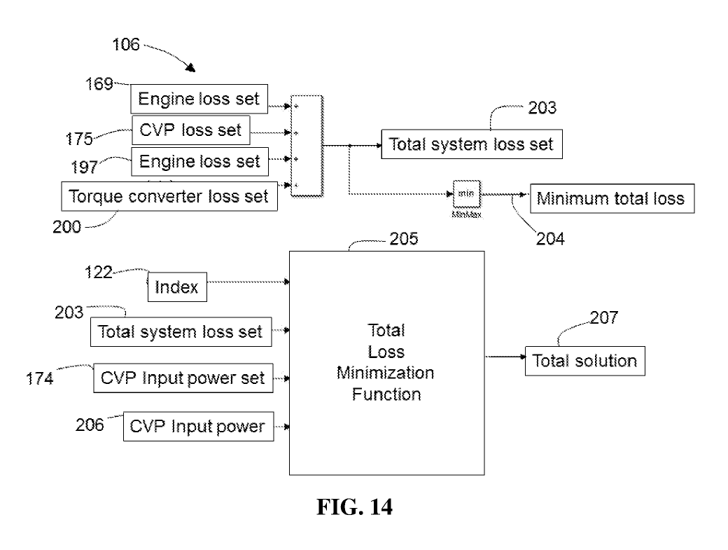

Turning now to FIG. 14, in one embodiment, the total system loss sub-module 106 is adapted to sum the engine loss set 169, the CVP loss set 175, the pump loss set 197, the torque converter loss 200 to form a total system loss set 203. In one embodiment, the total system loss sub-module 106 determines a minimum total loss 204 of the total system loss set 203. The total system loss set 203 is passed to a total loss minimization function 205. The total loss minimization function 205 receives the index 122, the CVP input power set 174 and a CVP input power signal 206. The total loss minimization function 205 determines a total solution 207. In one embodiment, the total solution 207 is a commanded CVP ratio that is associated with the minimum total loss for the desired operating condition of the vehicle. In some embodiments, the total solution 207 is based on the optimization of other performance metrics such as vehicle acceleration/deceleration, vehicle drivability, and drivetrain durability, among others. For example the optimal total solution can be filtered or rate limited for improved drivability. Alternatively, the optimal total solution can be altered for component speed or torque limitations or to accommodate any potential NVH avoidance zones.

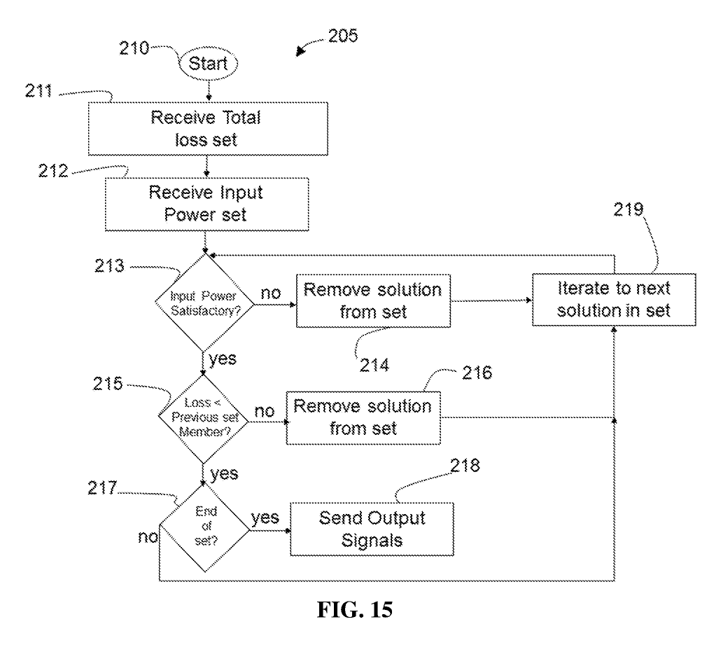

Referring now to FIG. 15, in one embodiment, the total loss minimization function 205 implements a control process that begins at a start state 210 and passes to a block 211 where the total system loss set 203, for example, is received. The process proceeds to a block 212 where the CVP input power set 174, for example, is received. The process proceeds to an evaluation block 213 where the input power request, for example the CVP input power signal 206, is compared to each value in the CVP input power set 174. If a value contained in the CVP input power set 174 is below the CVP input power signal 206, the evaluation block 213 returns a negative, or false value, and the process proceeds to a block 214 where the value is removed as a possible solution. A calibratable comparison threshold can be used in decision block 213. For example, the comparison threshold is configured to set system behavior such that input power requirements are strictly satisfied for performance purposes or, alternatively, a deviation from input power requirements can be allowed for efficiency improvement purposes. The process proceeds from the block 214 to a block 219 to iterate to the next solution in the set. If the value contained in the CVP input power set 174 is above the CVP input power set 174, the evaluation block 213 returns a positive, or true value, and the process proceeds to a block 215 where each member of the total loss solution set is compared to the previous total loss value. If a value contained in the total loss set 203 is above the previous value, the evaluation block 215 returns a negative, or false value, and the process proceeds to a block 216 where the value is removed as a possible solution. A calibratable comparison threshold can be used in decision block 215 to set system behavior such that minimum loss criteria is explicitly satisfied for optimal instantaneous efficiency or alternatively require that a potential solution be a certain amount better than a previous solution before being selected. This would account for the loss associated with the choice to select a new solution and the associated inertia torque consequences of moving the system to a new operating point. The process proceeds from the block 216 to a block 219 to iterate to the next solution in the set. If a value in the total loss set is below the previous value, the current value is temporarily held as the optimal solution and the process proceeds to a decision block 217 where a check is made to determine if the end of the set has been reached. If the end of the solution set has not been reached the process proceeds to the block 219 to iterate to the next solution in the set and Once the end of the potential solution set has been reached the process proceeds to block 218 where the previously determined minimum total loss solution and associated index signals are sent for use by modules and sub-systems in the control system.

Provided herein is a computer-implemented system for a vehicle having an engine coupled to a continuously variable transmission having a ball-planetary variator (CVP), the CVP having a plurality of balls, each ball provided with a tiltable axis of rotation, each ball supported in a carrier assembly, the carrier assembly operably coupled to a shift actuator, the computer-implemented system comprising: a digital processing device comprising an operating system configured to perform executable instructions and a memory device; a computer program including instructions executable by the digital processing device to create an application comprising a software module configured to manage a plurality of vehicle driving conditions; a plurality of sensors configured to monitor vehicle parameters comprising: a transmission output shaft speed, an engine speed, an engine torque, a vehicle speed, a CVP ratio, and a commanded transmission output torque; wherein the software module is configured to execute instructions provided by an optimization sub-module, wherein the software module is adapted to determine a commanded CVP ratio based at least in part on the commanded transmission output torque.

In some embodiments of the computer-implemented system, the optimization sub-module further comprises a solution set generator, a sub-system loss model, and a total system loss sub-module.

In some embodiments of the computer-implemented system, the sub-system loss sub-module further comprises a CVP loss sub-system.

In some embodiments of the computer-implemented system, the sub-system loss sub-module further comprises an engine loss sub-system.

In some embodiments of the computer-implemented system, the sub-system loss sub-module further comprises a hydraulic pump loss sub-system.

In some embodiments of the computer-implemented system, the sub-system loss sub-module further comprises a torque converter loss sub-system.

In some embodiments of the computer-implemented system, the total system loss sub-module is configured to determine the minimum total loss from a set of operating conditions.

In some embodiments of the computer-implemented system, the set of operating conditions are determined in the solution set generator.

In some embodiments of the computer-implemented system, the solution set generator determines a set of operating conditions that satisfy the commanded transmission output torque.

In some embodiments of the computer-implemented system, the total system loss sub-module is configured to determine a commanded CVP ratio based at least in part on the minimum total loss.

In some embodiments of the computer-implemented system, the solution set generator is configured to determine a set of CVP ratio solutions based at least in part on the vehicle speed and the commanded transmission output torque.

In some embodiments of the computer-implemented system, the solution set generator is configured to determine a set of engine speed solutions and a set of engine torque solutions, wherein the set of engine speed solutions and the set of engine torque solutions are based at least in part on the set of CVP ratio solutions.

In some embodiments of the computer-implemented system, the total system loss sub-module further comprises a total loss minimization function.

In some embodiments of the computer-implemented system, the total loss minimization function is configured to execute a process, the process comprising the steps of: receiving a total loss set comprising an indexed array of solutions for total system loss; receiving an input power set comprising an indexed array of solutions for input power; comparing the input power set to a requested input power signal; and selecting a minimum total loss operating condition based at least in part on the comparison of the requested input power signal to the input power set.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein are employable in practicing the invention. It is intended that the following claims define the scope of the invention and that methods and structures within the scope of these claims and their equivalents be covered thereby.

What is claimed is:

1. A computer-implemented system for a vehicle having an engine coupled to a continuously variable transmission having a ball-planetary variator (CVP), the CVP having a plurality of balls, each ball provided with a tiltable axis of rotation, each ball supported in a carrier assembly, the carrier assembly operably coupled to a shift actuator, the computer-implemented system comprising:
a digital processing device comprising an operating system configured to perform executable instructions and a memory device;
a computer program including instructions executable by the digital processing device, the computer program comprising a software module configured to manage the CVP and the engine;
a plurality of sensors comprising:
a transmission output shaft speed sensor configured to sense a transmission output shaft speed,
an engine speed sensor configured to sense an engine speed,
an engine torque sensor configured to sense an engine torque,
a vehicle speed sensor configured to sense a vehicle speed,
a CVP ratio indicator configured to indicate a CVP ratio, and
a commanded transmission output torque indicator configured to indicate a commanded transmission output torque;
wherein the software module is adapted to determine a commanded CVP ratio based at least in part on the commanded transmission output torque, the transmission output shaft speed, the engine speed, the engine torque, and the vehicle speed.

2. The computer-implemented system of claim 1, wherein software module further comprises a solution set generator, a sub-system loss model, and a total system loss sub-module.

3. The computer-implemented system of claim 2, wherein the sub-system loss sub-module further comprises a CVP loss sub-system module.

4. The computer-implemented system of claim 3, wherein the sub-system loss sub-module further comprises an engine loss sub-system module.

5. The computer-implemented system of claim 4, wherein the sub-system loss sub-module further comprises a hydraulic pump loss sub-system module.

6. The computer-implemented system of claim 5, wherein the sub-system loss sub-module further comprises a torque converter loss sub-system module.

7. The computer-implemented system of claim 4, wherein the total system loss sub-module is configured to determine the minimum total loss from a set of operating conditions.

8. The computer-implemented system of claim 7, wherein the set of operating conditions are determined in the solution set generator.

9. The computer-implemented system of claim 8, wherein the solution set generator determines a set of operating conditions that satisfy the commanded transmission output torque.

10. The computer-implemented system of claim 9, wherein the total system loss sub-module is configured to determine a commanded CVP ratio based at least in part on the minimum total loss.

11. The computer-implemented system of claim 10, wherein the solution set generator is configured to determine a set of CVP ratio solutions based at least in part on the vehicle speed and the commanded transmission output torque.

12. The computer-implemented system of claim 11, wherein the solution set generator is configured to determine a set of engine speed solutions and a set of engine torque solutions, wherein the set of engine speed solutions and the set of engine torque solutions are based at least in part on the set of CVP ratio solutions.

13. The computer-implemented system of claim 12, wherein the total system loss sub-module further comprises a total loss minimization function.

14. The computer-implemented system of claim 13, wherein the total loss minimization function is configured to execute a process, the process comprising the steps of:
receiving a total loss set comprising an indexed array of solutions for total system loss;
receiving an input power set comprising an indexed array of solutions for input power;
comparing the input power set to a requested input power signal;
comparing a loss value from the total loss set to a previous loss value from the total loss set;
determining the end of the total loss set; and
selecting a minimum total loss operating condition based at least in part on the comparison of the requested input power signal to the input power set.
